(19) United States
(12) Patent Application Publication
(10) Pub. No.: US 2011/0039118 A1
(43) Pub. Date: Feb. 17, 2011

(54) UNIVERSAL EVENT MEMENTO

(76) Inventor: Mark William Avery, Fountain Hills, AZ (US)

Correspondence Address: ROBERT A. PARSONS, 4000 N. CENTRAL AVENUE, SUITE 1220, PHOENIX, AZ, 85012, US

(21) Appl. No.: 12/857,360

(22) Filed: Aug. 16, 2010

Related U.S. Application Data
(60) Provisional application No. 61/274,284, filed on Aug. 17, 2009.

(51) Int. Cl. A47G 35/00; B23P 17/04

(52) U.S. Cl. 428/542.4; 29/592

(57) ABSTRACT

An event memento is disclosed which includes a body having a peripheral edge and a viewing surface on the body within the peripheral edge. The viewing surface has a predetermined shape relating to a particular category of sport or activity. A color is displayed on the body within the peripheral edge. The color is predetermined and relates to a particular feature of the particular category of sport or activity.

### CROSS-REFERENCE TO RELATED APPLICATION

This application claims the benefit of U.S. Provisional Application No. 61/274,284, filed 17 Aug. 2009.

### FIELD OF THE INVENTION

This invention relates to event mementos.

More particularly, the present invention relates to event mementos which convey specific information consistently.

### BACKGROUND OF THE INVENTION

For years, events of many sorts, and particularly athletic events, have been marked, commemorated, and/or celebrated by the sale and/or distribution of one or more mementos. For example, a marathon running event (26.2 miles) may offer each participant a commemorative t-shirt that includes the race name, date, and list of sponsors. The event may also offer other items, such as decals, key chains, and hats that include similar attributes. Participants in these events are a proud bunch. They are proud to not only display their athletic prowess by wearing the event t-shirt, but, they may go so far as to wear the commemorative event cap or other event-related merchandise. Doing so let's others know that the person is enthusiastic about the event, the cause, the sport, and, likely, has a certain amount of skill, fitness, and accomplishment. These items are walking bragging rights and held near and dear by the participants. In some cases, the person may wear commemorative items from different events, such as a commemorative triathlon event t-shirt and a commemorative Ironman® event cap. Wearing these items, particularly around other athletes, hardly goes unnoticed. In fact, a certain amount of gamesmanship amongst competitors can be generated by wearing such items in pre-race activities. They also serve as reminders to the participants of their accomplishments.

The downside of these typical expressions of accomplishment is that the person typically displays only one item at a time. In particular, a person can only wear one commemorative event t-shirt at a time, one commemorative event cap, and so on. Thus, there is a disadvantageous limit in displaying how much accomplishment there really is, in other words, how good they really are in a particular type or category of event or multiple categories. As impressive as one or two items may be, these participants would like to display the full history of their accomplishments. Thus, there is a need for an event memento or commemorative item that allows for many events to be displayed concurrently, preferably on the same item of clothing or equipment.

Another downside of these typical expressions of accomplishment is that they have a somewhat limited life. Commemorative event t-shirts, for example, are typically not worn by the participants more than a year or two, as clothing wears out, gets stained or dirty, and, frankly, is not fashionable to wear after such time. Dated t-shirts are just that: dated. Yet the participants would like to display their history of accomplishments. This “t-shirt paradox” is not easily solved, as the participants are loathe to discard these old event t-shirts, but are not particularly keen on wearing them in public after a period of time. Thus, there is a need to show a history of accomplishments over a long period of time.

Another downside of these typical expressions of accomplishment is that they do not typically recognize the participant's finishing place in the event, particularly if the participant was a top finisher or even the winner of the event. This problem is understandable because these items are mass produced in advance and designed as low-cost or giveaway items for the participants. Trophies and the like are oftentimes presented to the event winners, but these can be quite expensive. More importantly, the winners will not be reasonably able to display their trophies outside of their office or home. Dragging a trophy around to future events is not only logistically troubling, but dangerously crosses the line from subtly bragging to outright narcissism. Thus, there is a need for an event memento to designate winners in a low cost manner that is easily recognizable to others.

While it is known that some events do produce a patch or the like for the participants, the shapes typically vary from year to year, the designs are different, and they share no real relationship to one another except the event name. While patches from many events could be added to an article of clothing or equipment, it would be difficult to quickly recognize what they are and what they say. In fact, with so many different colors, shapes, and logos, the patches may give a completely different and disadvantageous impression of random event participation.

It would be highly advantageous, therefore, to remedy the foregoing and other deficiencies inherent in the prior art.

Another object of the present invention is to provide a consistent and easily recognized event memento and system for event participation.

### SUMMARY OF THE INVENTION

Briefly, to achieve the desired objects and advantages of the instant invention provided is an event memento. The event memento includes a body having a peripheral edge and a viewing surface on the body within the peripheral edge. The viewing surface has a predetermined shape relating to a particular category of sport or activity. At least one color is displayed on the body within the peripheral edge. The at least one color is predetermined and relates to a particular feature of the particular category of sport or activity.

In a further aspect of the present invention, the at least one color displayed on the body includes a colored border on the body within the peripheral edge. The colored border defines the shape of the viewable surface. In yet another aspect, the peripheral edge defines the shape of the viewable surface.

Also provided is a method of manufacturing an event memento. This method includes receiving information about an event category, associating the event category to a predetermined shape, receiving information about an event distance or feature, associating the event distance or feature with a predetermined color, and generating the event memento including a viewable surface with the predetermined shape and having a portion with the predetermined color.

In another aspect of the method, the step of generating the event memento further includes the step of forming a colored border of the predetermined color around the viewable surface.

In yet another aspect of the method, the step of generating the event memento further includes the step of providing a body having a peripheral edge defining the shape of the viewable surface.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a memento in the form of a patch according to the present invention;

FIG. 2 illustrates a selection of shapes that can be used for mementos according to the present invention;

FIG. 3 is another embodiment of a memento in the form of a patch according to the present invention; and

FIG. 4 is a block diagram illustrating a method of providing custom event mementos.

### DETAILED DESCRIPTION OF THE PREFERRED EMBODIMENTS

These and other needs are met by the present invention. The present invention is, among other things, a universal event memento, as it offers participants a low-cost, commemorative item or event memento that can be combined with similar mementos from other events to build an easily-recognized timeline of accomplishments and activities. As described herein, the present invention may be displayed en masse on an article of clothing, a bag or other piece of equipment, or on any sort of display device or medium. The achievements, races, events, and sporting disciplines would be instantly apparent utilizing the present invention.

In the following paragraphs, the present invention will be described in one or more preferred embodiments. However, the scope of features of the present invention extends far beyond the preferred embodiments, and there may be many future events or sports, perhaps not yet invented, that are contemplated by the present invention and are incorporated herein.

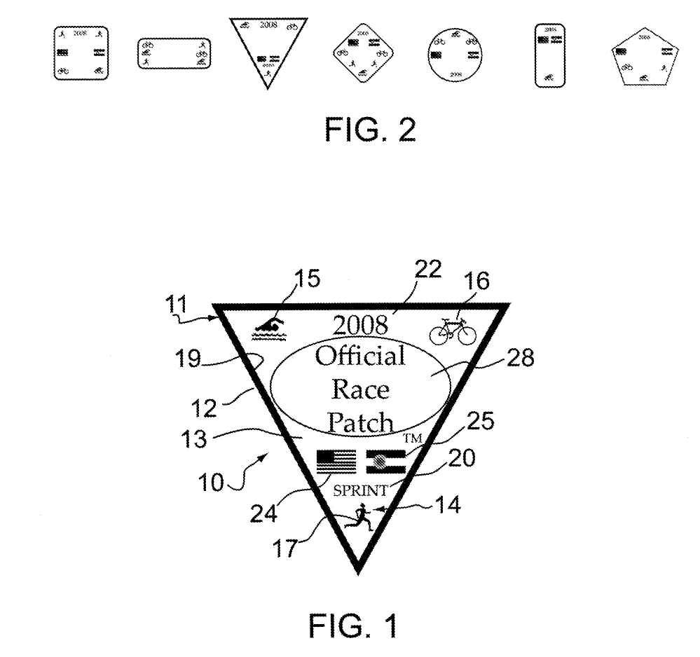

Turning now to the drawings in which like reference characters indicate corresponding elements throughout the several views, attention is first directed to FIG. 1 which illustrate an event memento, which, in this embodiment, takes the form of a patch generally designated 10. Patch 10 can be many of a variety of types of patches such as an embroidered patch, printed patch, or other type of textile or polymeric patch. Patch 10 includes at least one, and preferably up to ten features that relate specifically to a particular event, such as a triathlon, which is a sporting event that features a swim portion, bicycling portion, and running portion. These features will now be briefly described as relating to patch 10.

The first feature relating to patch 10 is a predetermined shape. Patch 10 includes a body 11, generally defined by a peripheral edge 12. In this embodiment, body 11 includes a viewing surface 13 defined by edge 12. The shape is preferably defined by peripheral edge 12 and corresponds to the viewing surface 13. However, as will be described subsequently, viewing surface 13 can be defined by another element (border) and thus, is itself in the shape desired, independent of the peripheral edge 12. In any case, the shape relates to and distinguishes a particular sport, event, or activity. For example, patch 10 for a triathlon (a specific category of events which category includes many different types of events) may have a predetermined shape of a triangle.

The second feature relating to patch 10 is a predetermined symbol or symbols 14 relating to a particular aspect or discipline of the event or more specifically category in which the event is a subset. For example, patch 10 for a triathlon may include symbols or icons of a swimmer 15, bicyclist 16, and a runner 17, or text representing these disciplines.

The third feature relating to patch 10 is a predetermined color relating to a specific event or activity within a category. The color may be displayed around the perimeter edge 12 of patch 10, such as in form of a border 19. It will be understood that other locations can be employed such as a color being displayed over the whole patch or in one or more other areas on the patch. In the present embodiment, by way of example, the distance of an event within a category, such as sprint triathlon, may be displayed by a colored patch border 19, such as green. Other types of events within the category of triathlon can be distinguished from one another by different color borders 19. It should be understood that when a border 19 is employed, it can designate the shape of the patch. In other words, a standard shaped patch, such as square, can be provided. In this specific embodiment, peripheral edge 12 denotes the shape of the overall patch, but not the shape of viewing surface 13. The shape of viewing surface 13 is defined by the shape of border 19. Thus, a square patch using a triangular border would be considered to have a triangular shape since this is the appearance it would present.

The fourth feature relating to patch 10 is a textual reference to the event distance 20. In the present example, a sprint triathlon may include the word “SPRINT” on the face of the patch.

The fifth feature relating to patch 10 is a textual reference to the year 22 in which the event occurred. For example, the text “2009” may be included on the patch for an event that occurred in 2009.

The sixth feature relating to patch 10 is a representation of a country flag 24 in which the event occurred. For example, a flag or the United States of America may be included on the patch for an event that occurred in the United States.

The seventh feature relating to patch 10 is a representation of a state flag 25 in which the event occurred. For example, a flag of Colorado may be included on the patch for an event that occurred in Colorado.

The eighth feature relating to patch 10 is a logo or emblem 26 of the event itself. For example, the name of the event, whether textual or in a graphical design, may be included on the patch.

The ninth feature relating to patch 10 is a predetermined area 28 for a participant's name, time, place, or other signifier to be, placed, whether manually or automatically. For example, there may be a box 28 shown on the patch for the participant to write in her triathlon finishing time.

The tenth feature relating to patch 10 is a representation of a sponsor logo or other third party logo that is associated with the event. For example, the logo of “ABC Company” may be included on the patch if ABC Company were a sponsor of the event.

As contemplated by the present invention, patches embodying one or more features in the above example, could be manufactured for events of many different sports, disciplines, events, and accomplishments, whereby a participant in those events could display the patches on a jacket, luggage, backpack, or other article. Patches with the features described herein allow for quick recognition of the category and type of event, and more specific information, such as event distance, location, time, and name of the event. In this manner, the present invention solves the problems of prior commemorative items and event mementos and provides many advantages to the participants.

The present invention may also include a special designation for event winners, top finishers, or other special designation. For example, a gold band may be displayed around patch 10 as an additional feature to signify the event winner.

The present invention is particularly advantageous for events that are part of a series of related events, or for events that a participant can repeatedly participate in over time. For example, a triathlon series comprising twenty races in a year may offer the present invention to the participants of each race. As a participant completes or participates in each event, the participant gains another patch, which has a consistent shape, color, and other one or more features as described herein. The participant can attach the patches to an article, such as a backpack, and display the patches concurrently, which reflect not only the participant's enthusiasm for the events, but also the participant's experience and accomplishments. And because the color and shape are consistent for the event and distance, a person seeing a plurality of patches on the participant's article could quickly see the participant's discipline specialty, geographic diversity in participation, and potentially the number of wins by the participant.

The present invention also includes a method of selecting and/or making a universal event memento. In one preferred method, one step includes selecting a peripheral edge defining a predetermined shape for the patch that corresponds to a particular category of sport, event, or activity. Another step includes selecting a predetermined color that corresponds to a particular type or distance or other related component within a category. Another step includes selecting the type of discipline, if applicable, within the sport, event, or activity. Another step includes selecting a date for the patch, the date relating to the year in which the event or activity is held. Another step includes selecting a country and/or state flag logo or emblem for the patch, these elements relating to the country and/or state in which the event is held. Yet another step is selecting a logo or emblem relating to the specific event or activity. Yet another step is providing a place to add, either manually or automatically, a finishing time or place. Yet another step is adding a sponsor logo, text, or emblem relating to the specific event or activity. In one preferred embodiment, the present invention includes providing a system using a computer network to receive selections and other ordering information, such as from a customer. These selections are then used to create a patch or other memento.

The present invention contemplates many different variations on the examples described above, and the number of combinations and features embodied by a universal event memento of the present invention are numerous. However, the following descriptions are intended to further explain the features and benefits of the present invention.

Although the present invention is preferably a patch, it is also contemplated that the event memento of the present invention could be a decal, emblem, plaque, flag, computer-generated image, or any other displayable medium. For ease of description, a “patch” is used herein, but as stated above, the event memento of the present invention is not limited to a patch. The size of the event memento can also vary. In one embodiment, the event memento has an area of between 4 in^{2 to} 9 in². However, the event mementos may be any size smaller or larger, although there may be limits on minimum size due to production limitations.

And while the present invention may have up to ten features relating to a particular event or activity, there could be less than ten or more than ten features displayed by the particular event memento of the present invention. In the preferred embodiment, there are at least two features presented, such as the predetermined shape relating to a category/sport, and predetermined color relating to the distance of the event within the category/sport.

Turning now to FIG. 2, some various shapes of patches are illustrated for categories of sports or activities. In the embodiment of FIG. 1, the predetermined shape of a triangle was used as relating to the sport of triathlon. Many sports, activities, shapes and combinations thereof are contemplated by the present invention. While any activity, sport or sporting event could be utilized under the present invention, the following illustrative examples demonstrate possible combinations of categories and shapes:

| | |
|---|---|
| Adventure Racing | Square |
| Ultra Running | Wide Rectangle |
| Triathlon | Triangle |
| Running | Diamond |
| Cycling | Circle |
| Boating | Tall Rectangle |
| Duathlon | Pentagon |
| Motorsports | Oval |
| Snow Skiing | Overlapped Triangles |

The above examples are not exhaustive or limiting to the present invention. Other sports events, whether conducted on land, water, or in the air, are also contemplated by the present invention. For consistency, it is preferred that once a shape is determined for a particular category, the shape, remains the same for all event mementos in the future for that category.

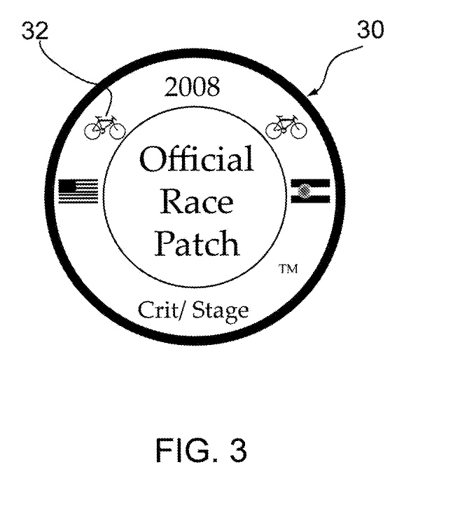

In one preferred embodiment, symbols are used to show a particular discipline of an activity, sport, or event. In the example given, a triathlon event memento may include symbols or icons of a swimmer, bicyclist, and a runner. However, many other symbols and/or logos are contemplated by the present invention. With reference to FIG. 3, in another preferred embodiment, a round patch 30 is illustrated. Patch 30 is used for a cycling event and features the logo of a mountain bike 32 because the event for which the patch was created is a mountain biking event. This same category of patch, namely cycling event can be altered to include the logo of a road bike for a road biking event. Many other sporting disciplines are contemplated by the present invention, including but not limited to boating, rafting, kayaking, canoeing, road cycling, mountain biking, track cycling, running, swimming, sailing, walking, skating, other land-related events and activities, other snow-related events and activities, other water-related events and activities, and other flying-related events and activities,

The present invention contemplates a predetermined color associated within a particular sport/category. The color may be displayed in any place on the event memento of the present invention, but in a preferred embodiment the color is displayed as a border around the memento. In one embodiment for a triathlon event, a triangular patch is employed, but the different distances within the sport of triathlon (e.g. sprint distance, Olympic® distance, half-Ironman® or “70.3” distance, and Ironman® or “140.6” distance) receive different colored borders, such as green, red, blue, and black, respectively. More than one color may be used on the same event memento of the present invention, such as a combination of red, white, and blue to signify a United States national championship event. In addition, a different discipline within the sport of triathlon, such as an off-road triathlon, may receive a different color or colors, accordingly.

In one embodiment for a motorsports event, an oval patch is employed, but the different distances that occur within the sport (e.g. quarter mile, half mile, three-quarter mile, one mile, mile and a half, etc.) would receive different colored borders, such as green, red, blue, yellow, and black, respectively. The present invention contemplates that any color may be assigned to a particular sport or perhaps discipline within the port but preferably this assignment is done in advance by an administrator of the system so that a customer ordering an event memento only has to pick the sport or discipline within the sport, and the color is automatically selected for the memento. The advantage of such a system allows for a consistent product that becomes known amongst the participants of a particular sport or discipline within the sport. For example, in the embodiment described above, it is contemplated that triathletes will recognize and associate a triangular patch with a green border as a sprint triathlon, and such recognition can occur quickly and at a distance.

Additional colors may be added to an event memento of the present invention. Such additional colors may be added to reflect a special designation, such as a race or event winner, whether overall or for a portion of the event or activity; a top finisher of the event or activity, whether overall or for a portion of the event or activity; a national, state, or series champion; a special event or activity, such as a tenth anniversary of an event; or a special participant award, such as recognition for completing all series events or participating in an event for a certain amount of time.

To demonstrate a consistent and recognizable system, with current mementos, compare a series of ten annual sprint triathlon event patches. A current set of such event patches likely consist of random shapes, sizes, colors, logos, etc. For a viewer of these patches, particularly if the patches are viewed quickly, they may not convey much information at all, and a more detailed study of the patches would be required to determine their significance and, indeed, the patch holder's accomplishments. A series of patches utilizing the present invention, however, would, according to one embodiment, all have the same, shape and color, such as a triangular patch with green border, which would immediately convey information to the viewer of the relationship among the patches. If the viewer of the patches were familiar with the system provided by the present invention, the, viewer would understand that the patches represent ten sprint triathlon events without any further investigation. This is advantageous to the patch viewer because of the quick information transfer, but also to the owner or displayer of the patches for the same reason and for other reasons described herein.

To further enhance the quick information transfer, in one embodiment of the present invention as illustrated in FIG. 1, there is included a textual reference to the event or activity, and/or discipline thereof. In this embodiment, the event type or distance 20 is designated using the word “SPRINT”, displayed on the face of event memento 10 to designate a sprint distance triathlon. Any other reference to a particular sport, discipline, or distance may be used, such as OLYMIC, 100K, 104.6, CENTURY, CAT II, 400M, 5000 FEET, 2 MILES, and so on. This element of the present invention adds even more information for conveying specific features of the event. The reference does not have to be textual, but could also be graphical in nature.

In the embodiment of FIG. 1, a textual reference to the year in which the event occurred is included. This feature also allows for further information transfer about the particular event. However, the feature is not limited to a year; instead, the reference could also be to a month, event series, race number, or other reference that conveys a chronological context for the event. Preferably, the chronological reference is selected by a customer when ordering one or mere event mementos. It is also contemplated that the chronological reference is automatically selected by the system.

Also, as described previously in the preferred embodiment, graphical depictions of a country flag and/or state flag are also provided on the event memento. Other geographical references may also be used, whether graphical or textual. A geographical reference is advantageous because it further enhances the information transfer of the memento and participant. It would desirable for a participant to collect event mementos from various states, countries, and other locales to further display the participant's accomplishments. In one embodiment, the geographic reference is selected by a customer when ordering one or more event mementos. In other situations, the geographic reference can be automatically selected by the system.

It is further contemplated that the event memento can include a textual or graphical reference to a particular event. For example, the “ABC Marathon” may have a race logo that is presented on the event's website, marketing materials, and event merchandise. This logo is also contemplated by the present invention to be placed on the event memento, and can be uploaded or sent by or from the customer or automatically included by the system of the present invention. As such, more specific information is conveyed by the event memento of the present invention. In this manner, the event memento of the present invention provides a race promoter with additional materials to further promote the event and build participant goodwill and loyalty. Even if the event logo changes over time, other elements contemplated by the present invention would remain the same, thus creating a consistent information transfer tool for participants, but also allowing the event promoter to change and update the event logo without fear of disrupting that information transfer.

The event memento can also include a textual or graphical reference to a particular event's sponsor. For example, if the “ABC Marathon” is sponsored by the “XYZ Company”, then such text or the, XYZ Company's logo may also be included on the event memento. In the preferred embodiment, the sponsor text or logo is uploaded or sent by or from the customer. The sponsor text or logo is advantageous in at least two ways. First, it allows for additional sponsor recognition and marketing benefits, which improves a sponsor' return-on-investment and builds goodwill among the participants and community. Second, it provides another asset for event promoters to sell to sponsors, which increases revenue and enhances the value offered by the event to potential sponsors.

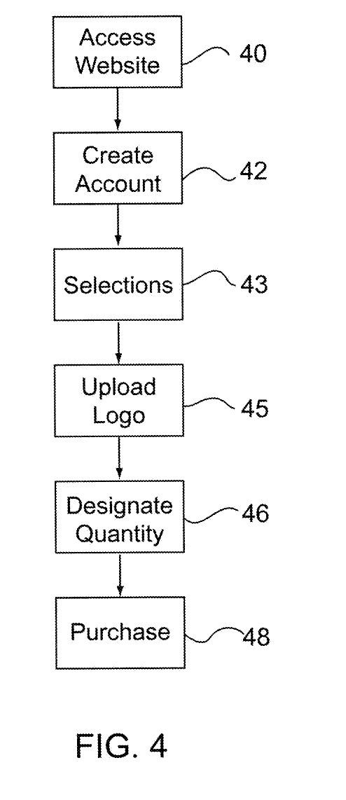

Turning now to FIG. 4, a method of creating a custom event memento is provided, wherein a customer accesses a website or similar computer network source 40, and inputs and/or upload information in order to design and order the event mementos for a particular event or activity. In this method, a customer creates an account 42 that includes a secure username and password. Through various prompts for information, the customer selects from a list of available sports or activities, distance or related information, event discipline, year, country, and state. These selections have been described in detail previously. The customer may also be prompted to upload 45 one or more logos for the event, sponsor, etc. Once the final design is completed and approved by the customer, an order may be placed for one or more event mementos 46. These designed mementos are then purchased 48 by the customer and fabricated by the supplier.

In this preferred embodiment, the customer is an event promoter. The event mementos can it be distributed to the event's participants and other persons or entities associated with the event.

One advantage afforded by the present invention is a universal appeal and association, even between or among different events and different promoters. In particular, the present invention contemplates use as a standard system for events and activities. As such, not only do event participants enjoy the commonality of certain features represented on the event mementos they receive for participating in events utilizing the present invention, but event promoters, sponsors, and related individuals and entities also benefit. In particular, event promoters that utilize the present invention receive additional marketing cache and cross-promotional advantages with other events that also utilize the present invention. In other words, event promoters will likely have more interest from participants if the event promoter offers an event memento as contemplated by the present invention. This is true whether the event promoter hosts one event or multiple events. In all cases, the network of events that utilize the present invention will have an advantage over events that do not utilize the present invention.

In one example wherein a race series promoter utilizes the present invention, the promoter creates event mementos for each race in a series. Even if the race series incorporates different disciplines, distances, and the like, the promoter is able to tie the races together by incorporating a series logo in each event memento. This adds a desirable feature to the participants, as they are motivated to participate in multiple events and/or the entire series, wherein full series participants may receive an additional “series memento” or the like. This also adds a desirable feature for the promoter as well, as it promotes the entire race series through each event memento.

Similar benefits may be achieved by the present invention by a registration company, such as an online registration company. For example, the event mementos of the present invention may be offered as an additional tool by the registration company for various event promoters. This offering may be utilized online or offline, and may be handled by the registration company or left for the promoter to complete. In addition to the economies of scale benefits afforded to registration companies, another advantage to a registration company utilizing the present invention is the ability to add its own logo to the event memento, or other graphical or textual data to promote their own services or provide a benefit to sponsors or partners of the registration company. Another benefit to the registration company is the opportunity to profit from event mementos purchased by event promoters. The event mementos contemplated by the present invention have clear and quantifiable marketing benefits, which translate into financial opportunities for event promoters as well as registration companies and others. For example, a registration company may add the opportunity for an event promoter to add a memento to the promoter's event for a fee, such as $1.00. Alternatively, the registration company could simply supply or mandate the memento for event promoters that utilize the registration company's services, whether a fee is included or not. Likewise, the event promoter may charge an additional fee for the memento to the event participants, or may simply provide them to the participants as an additional benefit for participating in the event. Depending on the circumstances, event promoters and/or registration companies could realize a significant income stream from the present invention.

Another advantage of the present invention is that the event mementos contemplated by the present invention are not only for participant, such as individuals participating in a sporting event, but may also be used as a commemorative memento for fans and spectators. In one embodiment, an event memento relates to a motorsports event, such as a NASCAR racing event, and fans that attend the race may receive or have the opportunity to purchase an event memento from the event, but wherein the event memento utilizes the specific characteristics contemplated by the present invention and described herein. In one preferred embodiment, an oval patch with a red border may be associated with an event at a half mile racetrack, such as for a race at the half mile Bristol Motor Speedway in Bristol, TN. Fans that receive or purchase this event memento may utilize the memento in similar ways as described herein. Such fans also may show their enthusiasm for the sport and different sanctioned tracks by collecting other mementos of the present invention from different tracks and events they host. In one embodiment, another oval event memento with a red border may represent the half mile Martinsville Speedway in Martinsville, Va. Thus, a fan that obtains and displays event mementos from both of these tracks and events they host will be able to show their affinity for this type of track and races at these tracks.

These and other advantages are now set forth by the present invention. While the detailed description herein provides certain embodiments and examples of the present invention, the embodiments and examples are not limiting, but merely illustrative and exemplary. The scope of the present invention reaches to a plurality of sports, colors, shapes, disciplines, and other specific information relating to events and activities. The present invention affords a truly universal event memento that can be a standard across a broad variety of sports, events, and activities.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. An event memento comprising:
a body having a peripheral edge;
a viewing surface on the body within the peripheral edge, the viewing surface having a predetermined shape relating to a particular category of sport or activity;
at least one color displayed on the body within the peripheral edge, wherein said at least one color is predetermined and relating to a particular feature of said particular category of sport or activity.

2. An event memento as claimed in claim 1 wherein the at least one color displayed on the body includes a colored border on the body within the peripheral edge, the colored border defining the shape of the viewable surface.

3. An event memento as claimed in claim 1 further including the peripheral edge defining the shape of the viewable surface.

4. An event memento as claimed in claim 1, wherein the viewable surface also includes at least one additional graphical or textual reference from the group consisting of event distance, event date, event country, event state, event discipline, event length, event logo, event sponsor, and event date.

5. A method of manufacturing an event memento comprising the steps of:
receiving information about an event category;
associating the event category to a predetermined shape;
receiving information about an event distance or feature;
associating the event distance or feature with a predetermined color; and
generating the event memento including a viewable surface with the predetermined shape and having a portion with the predetermined color.

6. A method as claimed in claim 5, wherein the step of generating the event memento further comprising the step of forming a colored border of the predetermined color around the viewable surface.

7. An event memento as claimed in claim 5, wherein the step of generating the event memento further comprising the step of providing a body having a peripheral edge defining the shape of the viewable surface.

8. A method as claimed in claim 5, further comprising the step of receiving at least one additional category of information about the event from the group consisting of event date, event country, event state, event discipline, event length, event logo, event sponsor, and event data and displaying the at least one additional category of information on the viewable surface.
